(19) United States
(12) Patent Application Publication
(10) Pub. No.: US 2003/0225756 A1
(43) Pub. Date: Dec. 4, 2003

(54) System and method for internet search using controlled vocabulary data

(76) Inventor: Songqiao Liu, Los Angeles, CA (US)

Correspondence Address: Marvin H. Kleinberg, KLEINBERG & LERNER, LLP, Suite 1080, 2049 Century Park East, Los Angeles, CA, 90067, US

(21) Appl. No.: 10/387,675

(22) Filed: Mar. 12, 2003

Related U.S. Application Data
(60) Provisional application No. 60/363,895, filed on Mar. 12, 2002.

(51) Int. Cl. G06F 7/00

(52) U.S. Cl. 707/3

(57) ABSTRACT

A method of generating a search request for a data repository includes the steps of invoking a command on a graphical user interface to activate a controlled vocabulary display program containing a controlled vocabulary, selecting at least one term of interest in the controlled vocabulary, retrieving additional terms related to the term of interest from the controlled vocabulary by a filter means selected by a user, and formulating a search query by combining the selected term and the related terms, according to a searcher's preferences.

### CROSS-REFERENCE TO RELATED APPLICATIONS

The present application is a continuation in part of U.S. provisional patent application serial No. 60/363,895, which is incorporated into the present application by this reference.

### BACKGROUND

1. Field of the Invention

The present invention relates to the use of controlled vocabulary data to facilitate and improve an Internet or database search.

2. Prior Art

A common problem that is faced by researchers when searching for material in information repositories is that the search returns either too much or too little. This is especially true when conducting a search of the Internet using a commercially available search engine. For example, if looking for material related to “apples” (the fruit), most Internet search engines would return information related not only to fruit, but also to the computer company that markets and sells the Apple® computer as well as other items.

One could add a number of additional search terms or, through “cut and paste” techniques, supplement the search criteria through the use of a controlled vocabulary or thesaurus which could supply yet additional search terms. Such a procedure would be time consuming and, to a great extent, incomplete. However, according to the present invention, it is possible to take advantage of controlled vocabularies to enhance the search of data repositories.

A controlled vocabulary is tool which can be used in fields that have a need to describe numerous and various items in a precise and exact manner. For example, a controlled vocabulary can be used by a museum to index the objects in its collection. A controlled vocabulary identifies terms used in a particular field or area, and defines relationships between the terms. A controlled vocabulary does not contain all possible terms that may be used in a particular field. Instead, it is a limited set of relevant terms that are used in a given field. A controlled vocabulary is a collection of descriptive terms. Examples of controlled vocabularies include thesauri, subject headings and classifications.

A major purpose of a controlled vocabulary is to match the terms brought to the system by a researcher with the terms used by an indexer. Whenever there are alternative names for a type of item, a indexer will have to choose one to use for indexing, and provide an entry under each of the others saying what the preferred term is. For example, a library controlled vocabulary may index all full-length works of fiction as “novels”. Then, someone who searches for “mysteries” must be told that they should look for “novels” instead. This is no problem if the two words are really synonyms, and even if they do differ slightly in meaning it may still be preferable to choose one and index everything under that. The controlled vocabulary will therefore indicate synonyms for terms within the controlled vocabulary.

A controlled vocabulary will also describe other types of relationships between words. For example, a controlled vocabulary will often organize terms in a hierarchical format. The term “novels” in the present example, can be a subset of the term “works of fiction” (which might also include “poems” and “short stories”). Thus, the controlled vocabulary will specify where in the hierarchy the terms fall. Broader terms and narrower terms can be specified. Other types of relationships can also be specified by the controlled vocabulary.

It is therefore a goal of the present invention to provide a system and method for refining database and Internet searches to achieve more meaningful results for a searcher.

It is another goal of the present invention to provide a system which will enable a controlled vocabulary to be dynamically used in Internet or database searching in order to automatically provide additional and meaningful search criteria to a search query according to a searcher's preferences.

### SUMMARY OF THE INVENTION

The present invention overcomes the limitations of the prior art by providing a system and method of generating a search request for a data repository using controlled vocabularies. The method includes the steps of invoking a command on a graphical user interface to activate a controlled vocabulary display program containing a controlled vocabulary, selecting at least one term of interest in the controlled vocabulary, retrieving additional terms related to the term of interest from the controlled vocabulary by a filter means selected by a user, and formulating a search query by combining the selected term and the related terms, according to a searcher's preferences. In the preferred embodiment, the data repository is the Internet, and the query is a URL which is constructed using the selected term and additional terms to improve precision or increase recall.

### BRIEF DESCRIPTION OF THE DRAWINGS

FIG. 1 is a block diagram showing a general purpose computer system which can implement the method of the present invention;

FIG. 2 illustrates a display window of a graphical user interface which is used to display the terms of a controlled vocabulary; and

FIG. 3 illustrates a search pane portion of the display window of FIG. 2.

### DETAILED DESCRIPTION OF THE INVENTION

A system and method of utilizing controlled vocabulary data to refine a search of a data repository will be described. In the following description, specific method steps and procedures are described in order to give a more thorough understanding of the present invention. In other instances, well known elements such as the operating system and specific software functions are not described in detail so as not to obscure the present invention unnecessarily.

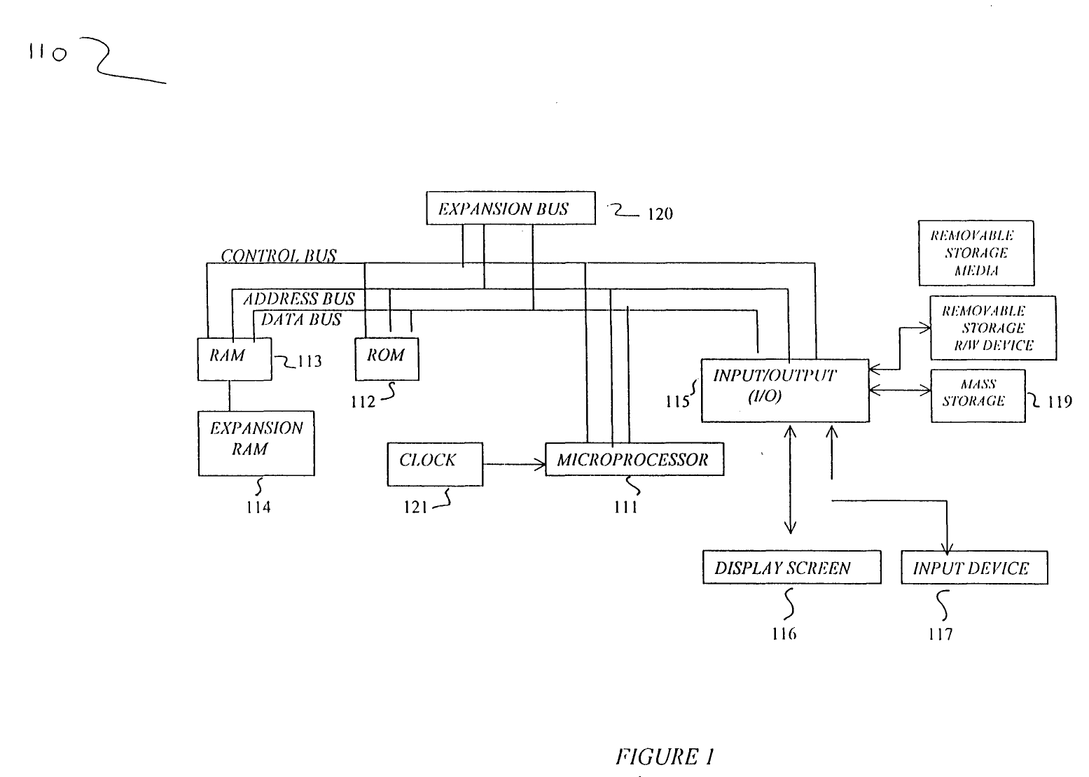

Referring first to FIG. 1, a block diagram of a general purpose computer system 110 which can be used to implement the method of the present invention is illustrated. Specifically, FIG. 1 shows a general purpose computer system 110 for use in practicing the present invention. As shown in FIG. 1, computer system 110 includes a central processing unit (CPU) 111, a read-only memory (ROM) 112, a random access memory (RAM) 113, expansion RAM 145, input/output (I/O) circuitry 115, a display assembly 116, an input device 117, and an expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient amount of RAM 113 and expansion RAM 114 to store user application programs and data. In that case, volatile RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The thesaurus data which is stored in the present invention will be generally be found on mass storage device 119.

In operation, information is input into the computer system 110 by typing on a keyboard, manipulating a mouse or trackball, or “writing” on a tablet or on position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system or web server.

Various other types of computers, however, may be used depending upon the size and complexity of the required tasks. Suitable computers include mainframe computers, multiprocessor computers and workstations. Typically, the program of the present invention will be stored on mass storage device 119 until a user of the computer system 111 initiates its operation. Portions of the program may then be transferred to RAM 113 while the program executes. Alternatively, the program of the present invention may reside in RAM 113 or ROM 112.

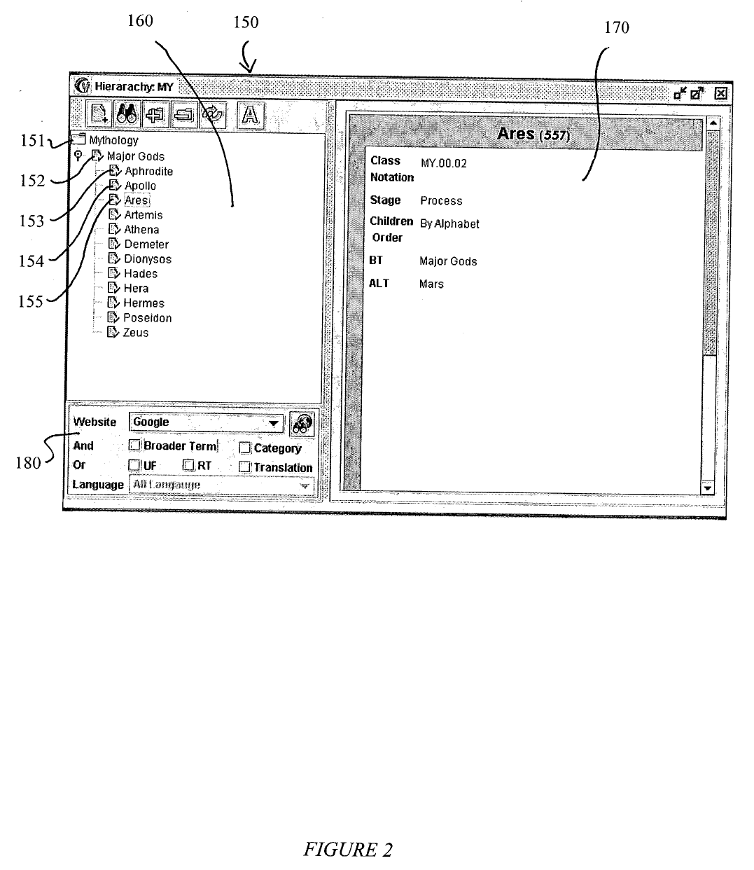

Referring next to FIG. 2, a display window 150 of a GUI is shown which contains the elements of the controlled vocabulary. The sample controlled vocabulary illustrated in FIG. 2 relates to the general field of mythology. It will be apparent to those of skill in the art that this example is given for illustrative purposes only, and that a controlled vocabulary for any conceivable type of subject can be used with equal effectiveness.

The controlled vocabulary elements 151, 152, 153, 154, etc. are displayed in display pane 160. As shown in FIG. 2, the terms are arranged in a hierarchical format. Display pane 170 displays the terms of the controlled vocabulary which are related to the particular term of interest, as will be described more fully below. The relationship of yet other, additional, terms to the selected term is also shown.

The controlled vocabulary terms are not limited to being displayed in the hierarchical format. In an alternative embodiment, the terms are organized alphabetically. Other arrangements can be used with equal effectiveness, such as string length or chronologically (e.g., by date of creation).

The operation of the method of the present invention is best illustrated by utilizing an example from the sample controlled vocabulary of FIG. 2. Referring again to FIG. 2, the controlled vocabulary, as noted above, relates generally to the subject of mythology, thus “Mythology” is one of the terms 151 in the controlled vocabulary.

Another term in the vocabulary is “Major Gods” 152. It is organized as a narrower term of “Mythology” 151 and is therefore shown as being indented in the hierarchical tree appearing in display pane 160. Further indented beneath the term “Major Gods” are a number of terms representing different, specific, gods including the term “Ares” 154.

The user of the present invention will select a term of interest which is to be searched in a data repository (such as the Internet or a proprietary database). The user selects the term of interest by navigating the hierarchy using standard tools such as cursor keys or a pointing device. A Boolean keyword search can also be used. In the example of FIG. 2, the term “Ares” 154 has been selected and is highlighted.

The computer system 110 will then retrieve the data file for the selected term, and display the detailed information for that particular term in display pane 170. A method of retrieving controlled vocabulary data in the form of thesaurus data which is used in the present invention is described in co-pending patent application Ser. No. ______, assigned to the assignee of the present invention.

With the method of the present invention, the user can therefore see the descriptor to be searched in its hierarchical context, and also view the descriptor's detail when moving from one descriptor to another. As a result, the user always knows exactly what is being searched. There is no guesswork and there is no ambiguity.

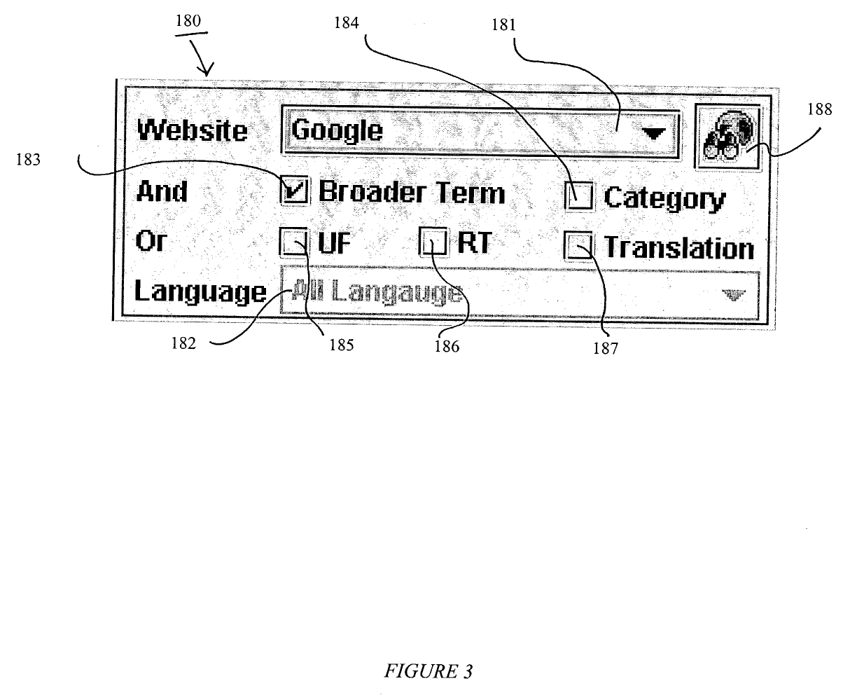

After the term of interest has been selected, the actual search process is accomplished using a search pane 180 portion of the display window 150. A more detailed view of the search pane 180 is illustrated in FIG. 3.

Turning next to FIG. 3, the web search pane 180 is illustrated according to a preferred embodiment of the present invention. Here, one can find a Website drop down list 181 in which the available search engines are listed. As shown, the search engine “GOOGLE” has been selected. Other search engines can be used with equal effectiveness. Examples include Yahoo, Alta Vista, Goto or DogPile. The user can also add any desired commercial search engine or custom Internet searching tool desired.

A Language drop down list 182 is also provided to permit searching in a specific language. In the present example, however, the default setting is “All Languages”. Additional boxes, which can add (AND) additional features such as Broader Term 183 and/or subject Category 184, when checked, can improve the precision of the search.

Other terms, which can be selected as alternatives (OR) such as the Synonyms (UF) box 185, the Related Terms (RT) box 186, or the Translation (Translation) box 186, can improve search recall. Referring to FIG. 2, the synonyms and related terms are set out within the display pane 170. A comprehensive search can then be undertaken with a minimal number of key strokes or mouse clicks. One need only select a term from a thesaurus tree and the various enhancements from the web search pane 180, and the search has the benefits of controlled vocabularies which can assist in framing the search request.

The searcher can see, at a glance, the available choices. For example, “Ares” is a rather obscure name for the god better known as Mars. The broader term “Major Gods,” will automatically be added when the Broader Term box 183 is checked. As a result, the precision of the search is improved. Similarly, the search will benefit from the use of alternative expressions (here “Mars”) which is accomplished by checking the UF box 185. When the “search” button is pressed, all of the search terms are sent to the search engine and, in the preferred embodiment, the display will switch to the search engine result page containing a list of the “hits”. In an alternative embodiment, the search results could be retrieved from the search engine and displayed on a pane, not unlike the pane of FIG. 2, including the hyperlinks that will enable direct access to each of the results.

If a search were to be conducted using only the word “Ares” and the selected engine, one would experience the conventional state of the art search. In an experiment utilizing the GOOGLE search engine, some 636,000 “hits” were noted with the search term “Ares”, clearly an unsatisfactory result. The present invention can refine the above search by ANDing the broader term of “Ares” to the search query. A search using GOOGLE will now return 325 pages, most of which are relevant. The system generates a query for the search engine by utilizing the selected terms and any related terms indicated in the search pane to construct a URL for the Internet search engine. In the present example given, the URL is formulated as: http://www.google.com/search?hl=en&safe=off&q=Ares+%22major+gods%22&btnG=Google+Search.

The present invention can also be used to broaden a search which does not return a large number of hits. As noted above, controlled vocabularies typically include synonyms for each term in the vocabulary. In another experiment utilizing a web site with substantial information about arts, a conventional search on the term “Ares” yielded no documents. However, the addition of the synonym (UF or ALT) “Mars” produced 39 relevant pages.

Accordingly, a system and method of using controlled vocabulary data to improve a database search has been described. It is to be understood that the foregoing description has been made with respect to specific embodiments thereof for illustrative purposes only. The overall scope of the present invention is limited only by the following claims.

What is claimed is:

1. A method of generating a search query for a data repository, comprising:
(a) invoking a command on a graphical user interface to activate a controlled vocabulary display program containing a controlled vocabulary;
(b) selecting at least one term of interest in said controlled vocabulary;
(c) retrieving additional terms related to said at least one term of interest from said controlled vocabulary by a filter means selected by a user;
(d) formulating the search query to be utilized by said data repository by combining said at least one selected term and said related terms.

2. The method of claim 1 wherein said data repository comprises the Internet.

3. The method of claim 1 wherein said data repository comprises a database.

4. The method of claim 1 wherein said search query comprises a specially-formulated URL to be used by an Internet search engine.

5. A method of generating a search query for a search engine on the Internet, comprising:
(a) invoking a command on a graphical user interface to activate a controlled vocabulary display program containing a controlled vocabulary;
(b) selecting at least one term of interest in said controlled vocabulary;
(c) retrieving additional terms related to said at least one term of interest from said controlled vocabulary by a filter means selected by a user;
(d) formulating the search query by combining said at least one selected term and said related terms into a URL to be utilized by the Internet search engine.
